(19) United States
(12) Patent Application Publication
(10) Pub. No.: US 2007/0046924 A1
(43) Pub. Date: Mar. 1, 2007

(54) Projecting light patterns encoding correspondence information

(76) Inventor: Nelson Liang An Chang, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/214,594

(22) Filed: Aug. 30, 2005

(51) Int. Cl. G01C 3/08; G01C 5/00

(52) U.S. Cl. 356/3.01

(57) ABSTRACT

In one aspect, a sequence of light patterns including cells having respective patterns of light symbols is projected onto a scene. The projected sequence of light patterns encodes pixels in a projection plane with respective temporal pixel codes corresponding to respective temporal sequences of light symbols coinciding with the locations of corresponding pixels. The projected sequence of light patterns uniquely encodes cells in the projection plane with respective temporal cell codes including respective sets of temporal pixel codes corresponding to respective sequences of light pattern cells. Respective temporal sequences of light patterns reflected from the scene are captured at regions of a capture plane. A correspondence mapping between the regions of the capture plane and corresponding cells in the projection plane is determined based at least in part on correspondence between the respective light pattern sequences captured at the capture plane regions and the temporal cell codes projected from the projection plane.

### CROSS-REFERENCE TO RELATED APPLICATIONS

This application relates to U.S. patent application Ser. No. 10/356,858, filed Feb. 3, 2003, by Nelson Liang An Chang et al. and entitled “MULTIFRAME CORRESPONDENCE ESTIMATION,” which is incorporated herein by reference.

### BACKGROUND

Solving the correspondence problem is a classic problem in computer vision and image processing literature. It is central to many three-dimensional related applications including stereopsis, three-dimensional shape recovery, camera calibration, motion estimation, view interpolation/synthesis, and others. Solving the correspondence problem also is important to display-related applications such as automatic keystone correction and automatic registration of multi-projector systems. The correspondence problem involves finding a mapping that relates points in one coordinate system to those in one or more other coordinate systems (e.g., a mapping between coordinates in the projection plane of one or more projectors and the capture planes of one or more cameras).

At their core, many of the aforementioned applications use at least one projector-camera pair. What is needed is an automated approach for determining a correspondence mapping between a camera and a projector that is based on the projection of light patterns encoding correspondence information, but does not require strong calibration between the camera and the projector (i.e., knowledge of the extrinsic and intrinsic geometric calibration parameters with respect to three-dimensional world coordinates is not required). Once established, this mapping may lead, either implicitly or explicitly, to the correspondence mapping across any pair of components in the complete imaging system.

### SUMMARY

In one aspect, the invention features a method in accordance with which a sequence of light patterns comprising cells having respective patterns of light symbols is projected onto a scene. The projected sequence of light patterns encodes pixels in a projection plane with respective temporal pixel codes corresponding to respective temporal sequences of light symbols coinciding with the locations of corresponding pixels. The projected sequence of light patterns uniquely encodes cells in the projection plane with respective temporal cell codes comprising respective sets of temporal pixel codes corresponding to respective sequences of light pattern cells. Respective temporal sequences of light patterns reflected from the scene are captured at regions of a capture plane. A correspondence mapping between the regions of the capture plane and corresponding cells in the projection plane is determined based at least in part on correspondence between the respective light pattern sequences captured at the capture plane regions and the temporal cell codes projected from the projection plane.

The invention also features apparatus implementing the above-described method and a machine-readable medium storing machine-readable instructions for causing a machine to perform operations implementing the above-described method.

Other features and advantages of the invention will become apparent from the following description, including the drawings and the claims.

### DESCRIPTION OF DRAWINGS

FIG. 1 is a diagrammatic view of an embodiment of a correspondence estimation system that includes a projector, a camera, and a computer.

FIG. 2 is a diagrammatic view of a correspondence mapping between the coordinate system of the projector and the coordinate system of the camera in the system shown in FIG. 1.

FIG. 3 is a block diagram of an implementation of the correspondence estimation system embodiment shown in FIG. 1.

FIG. 4 is a flow diagram of an embodiment of a method of determining a correspondence mapping between a projector and a camera.

FIG. 5 is a diagrammatic view of an embodiment of a sequence of projected light patterns encoding cells in a projection plane and a corresponding sequence of light patterns captured in a capture plane.

FIG. 6 is a flow diagram of an embodiment of a method of determining a correspondence mapping between a projector and a camera.

FIG. 7 shows an embodiment of an arrangement of temporal cell codes.

FIG. 8 shows an embodiment of an arrangement of temporal cell codes.

FIGS. 9A and 9B show respective light patterns that are designed in accordance with an embodiment of the invention.

FIG. 10 is a flow diagram of a method of synthesizing a view of a scene.

FIG. 11 shows temporal sequences of the light patterns that are projected and the code sets that are used for decoding in an implementation of the method shown in FIG. 10.

FIG. 12 is a flow diagram of an embodiment of a method of synthesizing a view of a scene.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. Introduction

The embodiments that are described in detail below provide an automated approach for determining a correspondence mapping between a camera and a projector that is based on the projection of light patterns that spatio-temporally encode correspondence information. This approach does not require strong calibration between the projector and the camera in order to determine the correspondence mapping. The light patterns encode pixels in the coordinate system of the projector in ways that allow the reflected light patterns that are captured at the capture plane of the camera to be decoded based on spatially local information. In this way, redundant temporal pixel codes may be used in encoding the correspondence information so that the total number of light patterns may be reduced, and enabling the speed with which correspondence mappings are determined to be increased. This speed increase improves the operation of various applications and enables synthetic views of time-varying scenes to be captured and synthesized with greater accuracy.

As used herein the term “pixels” refers to regions in the capture plane of a camera or the projection plane of a projector. Depending on the particular implementation of the correspondence estimation system, a pixel may correspond to one or more physical sensors elements of a camera or display elements of a projector. Some embodiments of the invention may operate at an effective resolution that is lower than the physical sensor or display elements.

### II. General Framework

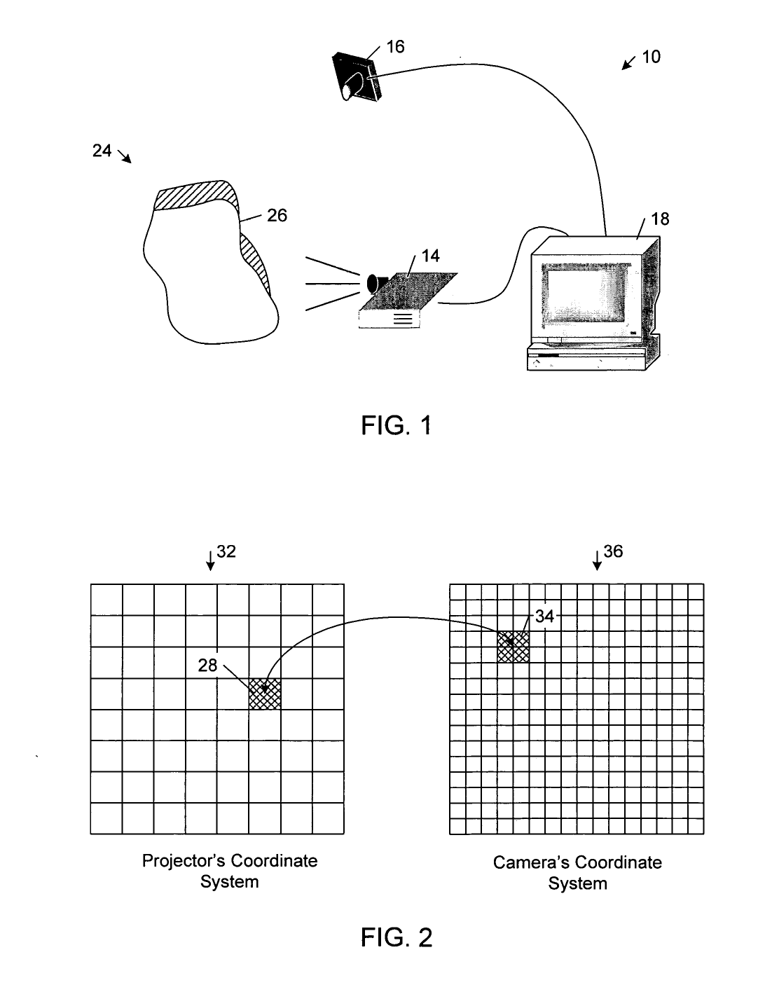

FIG. 1 shows an embodiment of a correspondence estimation system 10 that includes a projector 14, a camera 16, and a computer 18. In a correspondence estimation mode of operation, the projector 14 projects a sequence of light patterns onto a scene 24 and the camera 16 captures images reflected from the scene 24. As explained in detail below, the computer 18 coordinates the operation of the projector 14 and the camera 16 to obtain image data from which a correspondence mapping between a projection plane of the projector 14 and a capture plane of the camera 16 may be determined. In the illustrated embodiment, the scene includes a three-dimensional object 26. In general, however, the scene 24 may contain one or more of any type of objects and surfaces (e.g. planar, curved, or otherwise).

The projector 14 may be implemented by a wide variety of different types of light sources. Exemplary light sources include strongly colored incandescent light projectors with vertical slit filters, laser beam apparatus with spinning mirrors, LEDs, and computer-controlled light projectors (e.g., LCD-based projectors or DLP-based projectors). In the illustrated embodiments, the light projector 14 is a computer-controlled light projector that allows the projected light patterns to be dynamically altered using software. In another embodiment, a display device (e.g. television, CRT, LCD display, plasma, DLP rear projection system) could be viewed as a projector and surface combination such that it outputs images onto a rigid planar surface.

In general, the camera 16 may be any type of imaging device, including a computer-controllable digital camera (e.g., a Kodak DCS760 camera), a USB video camera, and a Firewire/1394 camera. USB video cameras or “webcams,” such as the Intel PC Pro, generally capture images 30 fps (frames per second) at 320×240 resolution, while Firewire cameras (e.g., Point Grey Research Dragonfly) can capture at higher frame rates and/or resolutions. The camera 16 typically remains fixed in place and is oriented toward the scene 24.

In some embodiments, the projector 14 and the camera 16 operate in the visible portion of the electromagnetic spectrum. In other embodiments, the projector 14 and the camera 16 operate in other regions (e.g., infrared or ultraviolet regions; color or strictly grayscale) of the electromagnetic spectrum. As explained in detail below, the actual 3-D location and orientation of the projector 14 with respect to the camera 16 need not be estimated in order to generate a correspondence mapping between the projector's coordinate system 32 and the camera's coordinate system 36.

The computer 18 may be any type of personal computer, portable computer, PDA, smart phone, or workstation computer that includes a processing unit, a system memory, and a system bus that couples the processing unit to the various components of the computer. The processing unit may include one or more processors, each of which may be in the form of any one of various commercially available processors. Generally, each processor receives instructions and data from a read-only memory and/or a random access memory. The system memory typically includes a read only memory (ROM) that stores a basic input/output system (BIOS) that contains start-up routines for the computer, and a random access memory (RAM). The computer 18 also may include a hard drive, a floppy drive, and CD ROM drive that are connected to the system bus by respective interfaces. The hard drive, floppy drive, and CD ROM drive contain respective computer-readable media disks that provide non-volatile or persistent storage for data, data structures and computer-executable instructions. Other computer-readable storage devices (e.g., magnetic tape drives, flash memory devices, and digital video disks) also may be used with the computer. A user may interact (e.g., enter commands or data) with the computer 18 using a keyboard, a pointing device, or other means of input. Information may be displayed to the user on a monitor or with other display technologies. In some embodiments, the computer 18 also may consist of one or more graphics cards, each of which is capable of driving one or more display outputs that are synchronized to an internal or external clock source.

During a correspondence estimation phase of operation, the computer 18 controls the projector 14 and the camera 16 and generates from the projected and captured image data a correspondence mapping between a coordinate system in the projection plane of the projector 14 and a coordinate system in the capture plane of the camera 16. As shown in FIG. 2, in this process, the computer 18 maps regions (or coordinates or points) 28 in a coordinate system 32 in the projection plane of the projector 14 to corresponding regions 34 in a coordinate system 36 in the capture plane of the camera 16. The computer 18 determines and refines the direct correspondences between the coordinate systems 32, 36 of the projector 14 and the camera 16 based on correspondences between light patterns that are projected from the projection plane of the projector 14 and the light patterns that are captured at the capture plane of the camera 16.

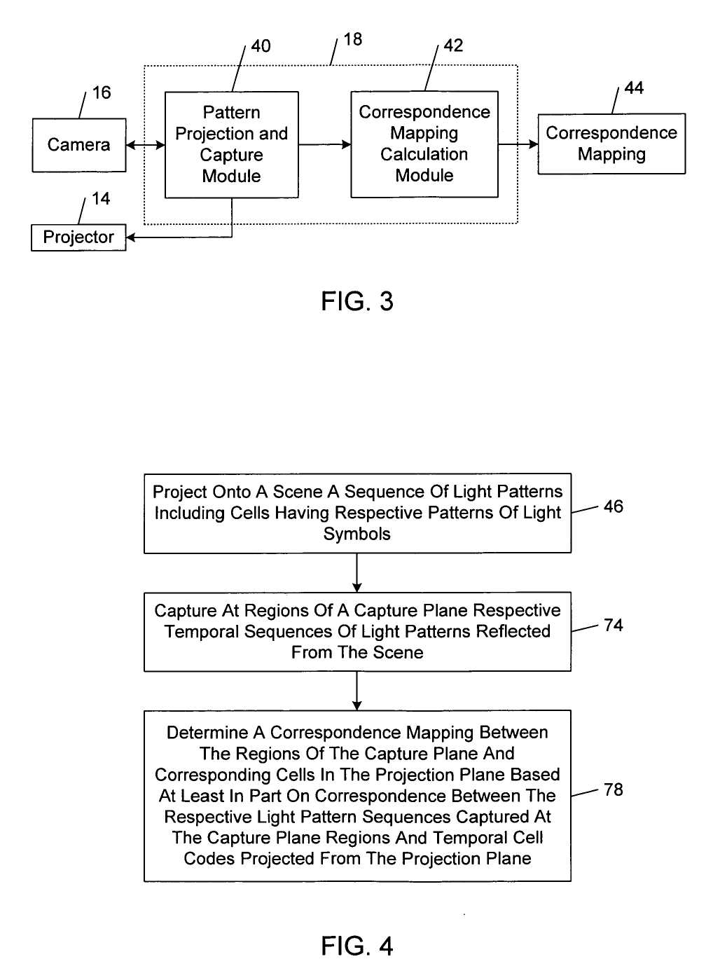

FIG. 3 shows an implementation of the correspondence estimation system 10 in which the computer 18 includes a pattern projection and capture module 40 and a correspondence mapping calculation module 42. In general, the modules 40, 42 may be implemented in any computing or processing environment, including in digital electronic circuitry or in computer hardware, firmware, or software. In the illustrated embodiments, the pattern projection and capture module 40 and the correspondence mapping calculation module 42 are implemented by one or more respective software modules that are executed on the computer 18. In some embodiments, these modules may be associated with the projector or camera or both. In these embodiments, there is no separate computer element per se as the operations of the modules 40, 42 are performed by the projector and/or camera.

In some implementations, computer process instructions for implementing the modules 40, 42 and the data generated by the modules 40, 42 are stored in one or more machine-readable media. Storage devices suitable for tangibly embodying these instructions and data include all forms of non-volatile memory, including, for example, semiconductor memory devices, such as EPROM, EEPROM, and flash memory devices, magnetic disks such as internal hard disks and removable disks, magneto-optical disks, and an optical disk, such as CD, CD-ROM, DVD-ROM, DVD-RAM, and DVD-RW.

In operation, the pattern projection and capture module 40 choreographs the projection of light patterns onto the scene 24 by the projector 14 and the capture by the camera 16 of light reflected from the scene 24 to ensure proper synchronization. The correspondence mapping calculation module 42 computes a correspondence mapping 44 between the coordinate system 32 in the projection plane and the coordinate system 36 in the capture plane based at least in part on correspondence between respective light pattern sequences captured at the capture plane and temporal codes encoded by a sequence of the light patterns that is projected from the projection plane.

### III. Determining Correspondence Mappings

FIG. 4 shows an embodiment of a method by which the correspondence estimation system 10 determines the correspondence mapping 44 between the coordinate system 32 of the projection plane of projector 14 and the coordinate system 36 of the capture plane of camera 16.

A. Projecting Light Patterns

During the correspondence estimation phase of operation, the computer 18 controls the projector 14 to project onto the scene 24 a sequence of light patterns that include respective arrangements of cells having respective patterns of light symbols (block 46).

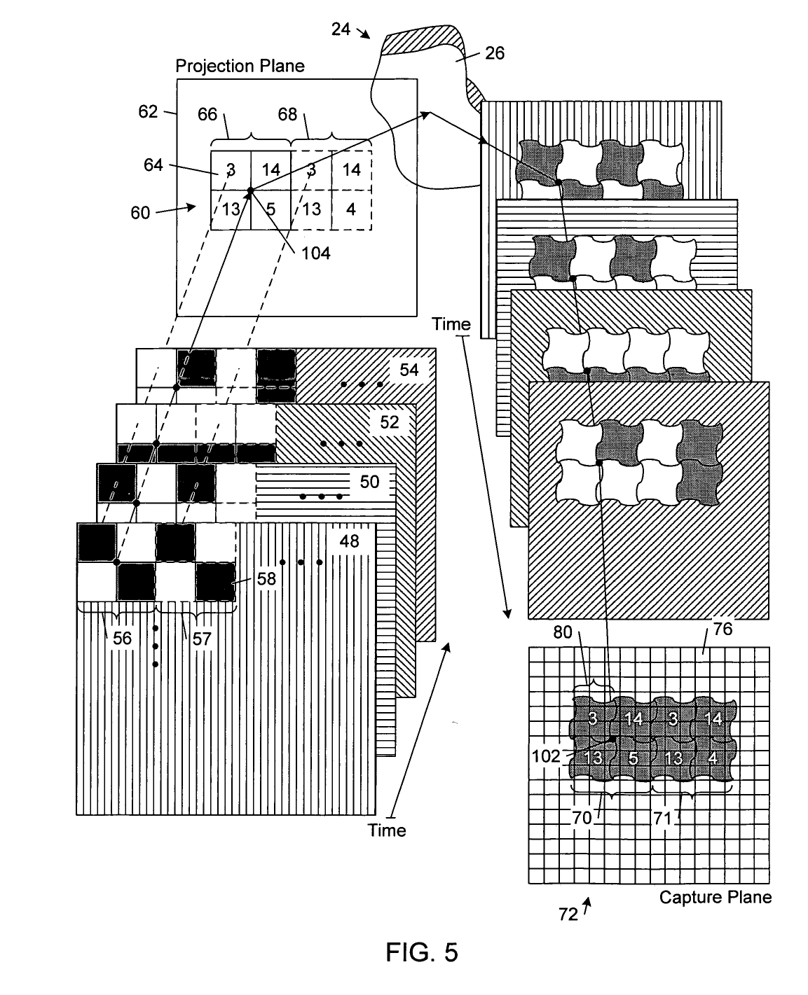

FIG. 5 shows an exemplary implementation of the correspondence estimation system 10 in which a sequence of four light patterns 48, 50, 52, 54 is projected onto the scene 24. Each light pattern 48-54 includes a respective arrangement of cells 56, 57. (In FIG. 5, only two of the cells are shown for each of the light patterns 48-54; additional cells in the light patterns are implied by the dotted lines.) Each of the cells 56, 57 includes a two-by-two rectangular array of light symbols 58. With respect to the illustrated example, P=4, M=N=C=2, and each light symbol 58 is selected from a dark color (e.g., black, which corresponds to no illumination) and a bright color (e.g., white, which corresponds to full illumination).

The projected sequence of light patterns 48-54 encodes the pixels 60 in the projection plane 62 with respective temporal pixel codes that correspond to respective temporal sequences of light symbols that coincide with the locations of the corresponding pixels. For example, the projected sequence of light symbols 58 that are located in the upper left corners of the light patterns 48-54 encodes the pixel 64 in the projection plane 62 with the color code sequence (dark, dark, bright, bright). In the exemplary implementation shown in FIG. 5, there are 2⁴=16 unique 4-bit temporal pixel codes. In the illustrated example, dark light symbols are translated into the binary value “0” and bright light symbols are translated into the binary value “1”. In this case, the color code sequence (dark, dark, bright, bright) is translated to the binary code (0011), which has the decimal value “3”. The sequence of projected light patterns 48-54 encodes the pixels in the projection plane cells 66, 68 with the following decimal values when decoded from left-to-right and top-to-bottom: 3, 14, 3, 14, 13, 5, 13, and 4. It is noted that the temporal pixel code values “3,” “13,” and “14” are each used to encode two different pixel locations in the projection plane 62.

Although the same temporal pixel codes may be used to encode different pixel locations in the projection plane 62, the projected sequence of light patterns 48-54 uniquely encodes each of the cells 66, 68 in the projection plane 62 with respective temporal cell codes. In the exemplary implementation shown in FIG. 5, there is a total of (2⁴−2)!/(2⁴−2−2*2)=14 !/10!=24,024 two-by-two spatial blocks that can be uniquely encoded by the various permutations of the light symbols in the sequence of four light patterns. As shown in FIG. 5, the temporal sequence of cells 56 in the upper left corners of the light patterns 48-54 temporally encode the cell 66 in the projection plane 62 with the unique decimal cell code (3, 14, 13, 5), which corresponds to the binary code (0011, 1110, 1101, 0101). Analogously, the temporal sequence of cells 57 that are shifted one cell to the right of the cells in the upper left corners of the light patterns 48-54 temporally encode the cell 68 in the projection plane 62 with the unique decimal cell code (3, 14, 13, 4), which corresponds to the temporal binary code (0011, 1110, 1101, 0100).

In general, each light symbol corresponds to a respective color that is selected from a set of C colors, where C has an integer value of at least two. A sequence of P light patterns is used to encode pixels and cells of pixels in the projection plane, where P has an integer value of at least two. The projected sequence of P light patterns encodes pixels in the projection plane with respective temporal pixel codes, where each temporal pixel code corresponds to a respective temporal sequence of light symbols that coincide with the location of the corresponding pixel. There are C^{p} distinct temporal pixel codes (i.e., light symbol sequences) that may be generated at every pixel location in the projection plane. In the illustrated embodiments, the same temporal pixel codes may be reused to encode different pixel locations in the projection plane.

The projected sequence of light patterns uniquely encodes cells in the projection plane with respective temporal cell codes that include respective unique sets of temporal pixel codes corresponding to respective sequences of light pattern cells. That is, although some of the pixels in the projection plane may be encoded with duplicate temporal pixel codes, each cell in the projection plane is encoded with a unique respective temporal cell code. In this way, the number of light patterns that is needed to encode the coordinate system in the projection plane may be reduced, thereby decreasing the time needed for the correspondence estimation system 10 to determine the correspondence mapping between the projection plane of the projector 14 and the capture plane of the camera 16.

In general, the light pattern cells, and consequently the cells in the projection plane, may include any type of patterns of light symbols. In the illustrated embodiments, each cell consists of M rows and N columns of light symbols, where M and N have positive integer values and at least one of M and N has a value of at least two. In these embodiments, there are a total of C^{P}!/(C^{P}−M·N)! spatial blocks of M×N pixels that can be uniquely encoded by the various permutations of the light symbols in the sequence of P light patterns (i.e., no duplicate temporal cell codes are used to encode the cells in the projection plane). For these embodiments, the maximum projector plane resolution w×h that can be encoded by the sequence of light patterns is given by:
C^{P}!/(C^{P}−M·N)!≦w·h (1)
where w and h respectively are the width and height of the projector space measured in pixels.

In some of the implementations that are described below, temporal pixel codes that consist of the same color across light patterns are not used to encode coordinates in the projection plane. In these implementations, the maximum number of temporal pixel codes that C colors can produce in P light patterns is reduced to C^{P}−C, in which case the maximum achievable projector plane resolution that can be encoded by a sequence of P light patterns is:

$$\frac{( {C}^{ P} - C ) !}{( {C}^{P} - C - M \cdot N ) !} \leq w \cdot h \qquad ( 2 )$$

In the exemplary embodiment described above in connection with FIG. 5, the temporal binary code is formed with the most significant bit corresponding to the earliest projection time. Other embodiments form the temporal binary code using other functions of time. In one exemplary embodiment, the sequence (dark, dark, bright, bright) is translated in reverse chronological order as a binary code 1100.

Likewise, the temporal binary code is interpreted above based on a spatial decoding order from left-to-right and top-to-bottom. In other embodiments, different spatial decoding orders may be used, such as decoding the coordinate values in each cell in a clockwise sequence or a counter-clockwise sequence.

In one embodiment, the temporal cell codes may be designed to be invariant to rotation (i.e., they can be decoded even if the camera and/or projector are rotated with respect to each other). For example, in one implementation, the temporal cell code

$$( \begin{matrix}a & b \\ c & d\end{matrix} ) \qquad ( 3 )$$

consisting of symbol values a, b, c, d, each representing temporal pixel codes in a M=N=2 configuration, would map to the same respective projection plane point as temporal cell codes

$$( \begin{matrix}b & d \\ a & c\end{matrix} ) , ( \begin{matrix}d & c \\ b & a\end{matrix} ) , ( \begin{matrix}c & a \\ d & b\end{matrix} ) \qquad ( 4 )$$

In this case, the maximum achievable resolution would be one quarter of the resolution given in equations (1) and (2).

In some embodiments, multi-colored light patterns are used to encode the pixels in the projection plane with only two light patterns. In one of these embodiments, C=8, P=2, M=N=2, where the eight colors represent, for example, the vertices of the color spectrum (black, red, green, blue, yellow, cyan, magenta, and white). In these implementations, there are a total of C^{p}−C=8²−8=56 unique temporal symbols (i.e., every unique pairing of these colors for a given pixel location). In one implementation of this embodiment, each of the permissible temporal pixel codes includes one black symbol (i.e., only the symbols in which one of the two temporal light symbols is black are allowed). Although this feature reduces the number of unique temporal pixel codes to fourteen (i.e., KR, KG, KB, KY, KC, KM, KW, RK, GK, BK, YK, CK, MK, and WK, where K, R, G, B, Y, C, M, and W represent black, red, green, blue, yellow, cyan, magenta, and white, respectively), this feature allows the non-illuminated color texture of the scene 24 to be captured at each of the pixel locations. The fourteen temporal pixel codes enable a maximum of 14×13×12×11=24,024 different 2×2 spatial cells to be encoded in the projection plane. This is sufficient for theoretically encoding a projector resolution of 128×128 pixels. By encoding the projector plane using only two light patterns, this embodiment enables nearly instantaneous determination of the correspondence mappings and therefore may be used in real-time and interactive projector-camera applications.

In other embodiments, the capture rate may be traded for higher resolution by increasing the number of projected light patterns. In one of these embodiments, P=3, C=3, M=N=2, where the colors are, for example, black, white, and gray. This embodiment has a higher maximum resolution of 500×500 than the previous embodiment, but it is characterized by slightly slower capture rates. Moreover, it may be more advantageous to have fewer overall colors C to improve decoding robustness.

B. Capturing Light Patterns

Referring to FIGS. 4 and 5, the camera 16 captures at regions 70, 71 of a capture plane 72 respective temporal sequences of light patterns reflected from the scene 24 (block 74; FIG. 4). In particular, the camera 16 includes one or more light sensors that form an array of pixels 76 that defines a coordinate system in the capture plane 72. The captured light patterns are processed temporally and decoded to form codes in the capture plane. As shown diagrammatically in FIG. 5, the light patterns that are captured at the capture plane 72 may correspond to skewed or otherwise distorted versions of the corresponding ones of the pixels and cells that are projected from the projection plane 62. In addition, the light reflected from the scene 24 that corresponds to a given one of the projection plane pixels (e.g., the pixel encoded with a “3” in cell 66) may be captured by more than one pixel 76 in the capture plane 72.

C. Determining a Correspondence Mapping from the Captured Light Patterns

1. Overview

The correspondence mapping calculation engine 42 determines a correspondence mapping between the regions 70, 71 of the capture plane 72 and corresponding cells in the projection plane (block 78; FIG. 4). This determination is based at least in part on correspondence between the respective light pattern sequences that are captured at the capture plane regions 70, 71 and the temporal cell codes that are projected from the projection plane 62.

In some implementations, the correspondence mapping calculation engine 42 temporally decodes the captured light pattern values at each of the pixels 76. The correspondence mapping calculation engine 42 groups the pixels 76 with the same decoded temporal pixel codes into spatial clusters 80 of pixels 76. The correspondence mapping calculation engine 42 matches groups 70, 71 of pixel clusters 80 in the capture plane 72 with the cells 66 in the projection plane 62 based upon correspondence between the projected temporal pixel codes and the captured temporal pixel codes. The correspondence mapping calculation engine 42 determines the correspondence mapping by mapping specific points in the pixel cluster groups 80 in the capture plane 72 to respective specific points in the corresponding cells 66, 68 in the projection plane 62.

2. General Framework

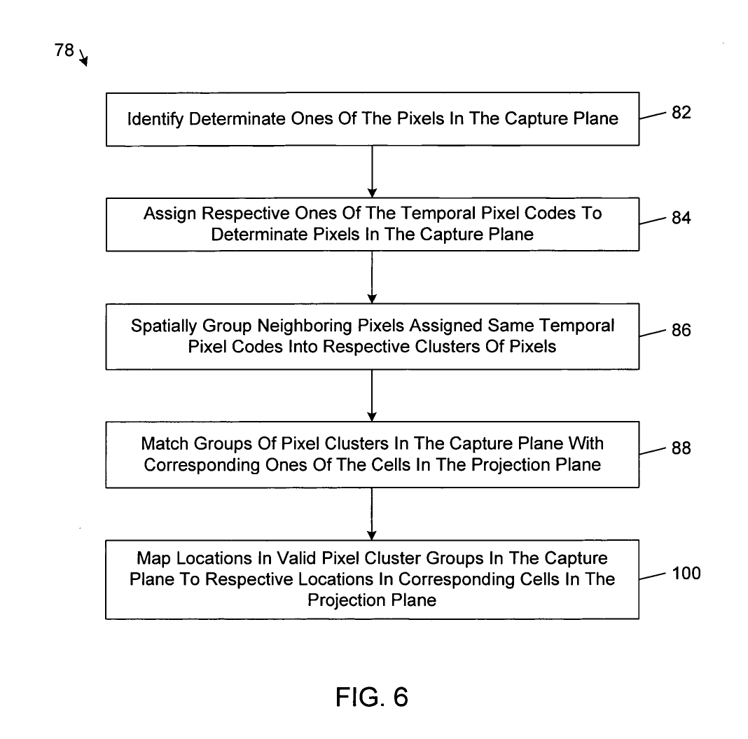

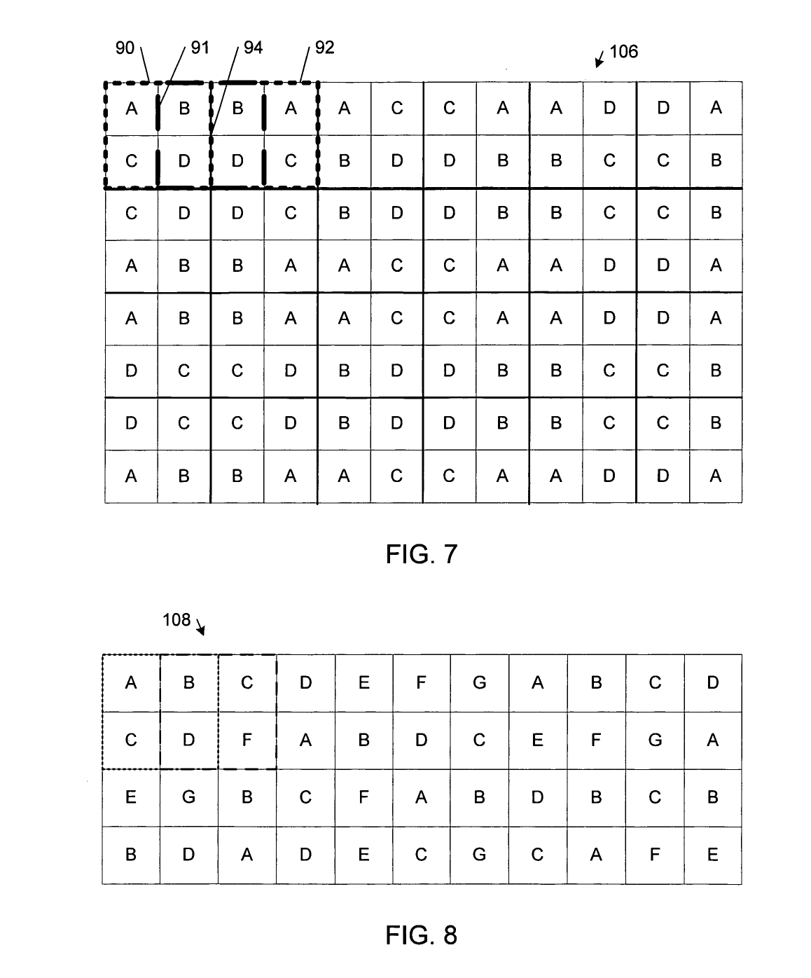

FIG. 6 shows an embodiment of the process shown in block 78 of FIG. 4. In this process, the correspondence mapping calculation engine 42 determines a correspondence mapping between locations in the projection plane and locations in the capture plane based at least in part on correspondence between the respective light pattern sequences that are captured at the capture plane regions 70, 71 and the temporal cell codes that are projected from the projection plane 62.

In accordance with this embodiment, the correspondence mapping calculation engine 42 identifies determinate ones of the pixels in capture plane (block 82; FIG. 6). In this process, the correspondence mapping calculation engine 42 labels as “determinate” the ones of the pixels in the capture plane that correspond to scene points visible to both the projector and camera. Similarly it labels as “indeterminate” the ones of the pixels in the capture plane that correspond to occluded or off-screen regions in the capture plane that are visible from the viewpoint of the projector 14 but not the viewpoint of the camera 16 or vice versa. In some embodiments, the temporal pixel codes that consist of uniformly colored light symbols, such as all dark light symbols (e.g., binary code “0000” in the exemplary implementation shown in FIG. 5) and all bright light symbols (e.g., binary code “1111” in the exemplary implementation shown in FIG. 5), are not permitted. In these embodiments, the capture plane pixels that are associated with uniformly colored pixel codes are labeled as “indeterminate”; the capture plane pixels that are associated with non-uniformly colored pixels are labeled as “determinate”.

The correspondence mapping calculation engine 42 assigns respective ones of the temporal pixel codes to the determinate pixels in the capture plane (block 84; FIG. 6). In this process, the correspondence mapping calculation engine 42 first determines for each determinate pixel the symbol values corresponding to the sequence of light patterns captured at the pixel location.

In some implementations, the correspondence mapping calculation engine 42 computes for each determinate pixel one or more thresholds that maximally separate the different light symbol colors based on the captured sequence of P pixel values corresponding to the projected sequence of P light patterns. For example, in embodiments in which there are only two colors (e.g., dark and bright), the correspondence mapping calculation engine 42 computes for each pixel a single threshold that maximally separates the dark and bright ones of the captured sequence of P pixel values corresponding to the projected sequence of P light patterns. The luminance or magnitude of the captured pixel values may be used to determine the respective threshold value at each pixel. The temporal pixel codes are assigned to the determinate ones of the capture plane pixels based on the computed threshold values. For example, in embodiments in which there are only two colors (e.g., dark and bright), pixel values above the corresponding pixel thresholds are labeled “bright” and pixel values below the corresponding pixel thresholds are labeled “dark”.

In other implementations, the correspondence mapping calculation engine 42 classifies temporal samples of the captured light patterns using a function of the color differences. In some embodiments, each of the permissible temporal pixel codes has at least one dark light symbol. In these embodiments, the pixel value with the minimum intensity for each temporal sequence of P captured light symbols is labeled as a dark symbol. In some implementations, the intensity value is given by equation (2):
Intensity=\sqrt{Rᵢ²+Gᵢ²+Bᵢ²} (5)
where Rᵢ, Gᵢ, and Bᵢ are the red, green, and blue color components of light captured at a given pixel and corresponding to a given projected light symbol i. Other intensity functions may be used.

For each pixel location, the maximum color component difference between the labeled dark symbol and a given temporal light symbol i are determined, as follows:
ΔR_{MAX,i}=|Rᵢ−R_{DARK}| (6)
ΔG_{MAX,i}=|Gᵢ−G_{DARK}| (7)
ΔB_{MAX,i}=|Bᵢ−B_{DARK}| (8)
The maximum Mᵢ of the color differences then is determined in accordance with equation (6):
Mᵢ=MAX(ΔR_{MAX,i},ΔG_{MAX,i},ΔB_{MAX,i}) (9)

where MAX( ) is the maximum function that returns the maximum one of the list of values. If Mᵢ is not greater than a predetermined threshold, the capture plane pixel value corresponding to the projected light symbol i is labeled as indeterminate. If Mᵢ is greater than a predetermined threshold, the capture plane pixel value corresponding to the projected light symbol i is assumed to have contributions from each color component for which the maximum color difference is greater than a predetermined fraction (e.g., 80%) of Mᵢ. For example, if ΔR_{MAX,i}>0.8Mᵢ, the light symbol is assumed to have a contribution from the red color component. In some implementations, the light symbol colors are assigned to the capture plane pixels based on the determined constituent sets of color components, as follows:

TABLE 1

| CONSTITUENT COLOR | ASSIGNED SYMBOL |
|---|---|
| COMPONENTS | COLOR |
| Red | Red |
| Green | Green |
| Blue | Blue |
| Red, Green | Yellow |
| Green, Blue | Cyan |
| Red, Blue | Magenta |
| Red, Green, Blue | White |

The use of relative color differences in the above approach typically is more resilient to decoding errors than approaches that use absolute color differences. In addition, this approach avoids requiring a priori color thresholds that may vary based on lighting and the contents of the scene.

It should be noted that it is possible to use the above framework to detect additional colors and relative proportions of hues based on the thresholding. For instance, the symbol colors “bright red” and “medium red” and “dark red” may be used based on thresholds of, for example, 75%, 50%, and 25%, relative to the identified dark value.

The sets of symbol colors that are assigned to the determinate ones of the pixels in the capture plane correspond to respective ones of the permissible temporal pixel codes that are projected from the projection plane of the projector 14. In some implementations, symbol colors are assigned to the indeterminate ones of the capture plane pixels by interpolating between neighboring determinate pixels.

After symbol colors have been assigned to determinate pixels of the capture plane pixels, the correspondence mapping calculation engine 42 then determines the appropriate temporal pixel code for each determinate pixel based on the predetermined and mutually established decoding order (i.e. most significant symbol corresponds to the earliest temporal light pattern).

Once temporal pixel codes have been assigned to determinate ones of the capture plane pixels (block 84; FIG. 6), the correspondence mapping calculation engine 42 spatially groups neighboring pixels that are assigned the same temporal pixel codes into respective clusters of pixels (block 86; FIG. 6). In this process, pixels are grouped together based on their assigned temporal pixel codes and their mutual spatial proximity. In some embodiments, a pixel connectivity process is applied to the temporal pixel codes that are assigned to the pixels to group the pixels into clusters.

Next, the correspondence mapping calculation engine 42 matches groups of pixel clusters in the capture plane with corresponding ones of the cells in the projection plane (block 88; FIG. 6). In this process, the correspondence mapping calculation engine 42 identifies the groups of pixel clusters in the capture plane that are encoded with respective ones of the projected temporal cell codes. Since each of the temporal cell codes is unique, there should be a one-to-one correspondence between the groups of pixel clusters and the cells in the projection plane. The correspondence mapping calculation engine 42 may use any one of a wide variety of different approaches to identify the valid groups of pixel clusters. In some implementations, the correspondence estimation system 10 projects features that demarcate the cells in the projection plane. For example, the light patterns may be configured to produce a respective boundary feature (e.g., a detectable dark border) around each of the cells in the projection plane. The correspondence mapping calculation engine 42 may determine the valid pixel cluster groups by registering the decoding process with respect to the detected cell boundary features.

3. Mapping Locations Between the Projection Plane and the Capture Plane

After groups of pixel clusters in the capture plane have been matched with corresponding ones of the cells in the projection plane (block 88; FIG. 6), the correspondence mapping calculation engine 42 maps locations in valid pixel cluster groups in the capture plane to respective locations in corresponding cells in the projection plane (block 100; FIG. 6).

In some embodiments, the correspondence mapping calculation engine 42 detects transitions between the decoded symbols in the capture plane to identify the intersection points between the symbols within valid pixel cluster groups. FIG. 5 shows an exemplary mapping of a light symbol intersection point 102 in the capture plane 72 to a corresponding light symbol intersection point 104 in the projection plane 62. In one approach, an edge/curve detection process is used to generate parameterized curves between the decoded symbols, and intersections between the parameterized curves are identified to find the light symbol intersection points.

In one implementation, the correspondence mapping calculation engine 42 applies a sliding 2-pixel×2-pixel window over the pixels of the capture plane and determines that the center of the window corresponds to a respective light symbol intersection point when the four decoded temporal pixel codes within the window that correspond to a valid temporal cell code. In another implementation, the correspondence mapping calculation engine 42 applies a sliding 5-pixel×5-pixel window over the pixels of the capture plane and determines that the center of the window corresponds to a respective light symbol intersection point when there are at least four different decoded temporal pixel codes within the window that correspond to a valid temporal cell code.

The correspondence mapping calculation engine 42 then maps the identified light symbol intersection points to the symbol intersection points within corresponding ones of the cell in the projection plane. In some embodiments, the correspondence estimation system 10 stores a table that relates temporal cell codes with the light symbol intersection points within the corresponding cells in the projection plane. In these embodiments, the correspondence mapping calculation engine 42 maps the light symbol intersection point that is identified for a given valid pixel cluster group to the corresponding point in the projection plane by looking-up the decoded temporal cell code for the given pixel cluster group in the table and retrieving the corresponding location in the projection plane.

4. Alternative Embodiments of Temporal Cell Code Arrangements

This section discusses two embodiments of projected temporal cell code arrangements: a non-overlapping temporal cell code arrangement and an overlapping temporal cell code arrangement. In both of these embodiments, when the light patterns are projected, there is no guarantee that when the light symbols are reflected and captured, immediate left-right and top-bottom light symbol neighbors in the projection plane will remain immediate neighbors in the capture plane. This introduces the problem of correctly identifying the boundaries of valid cells in the capture plane.

In the non-overlapping temporal cell code arrangement, the correspondence mapping calculation module 42 first must identify the boundaries of the valid cells (i.e., the cells corresponding to valid cell codes, not the cells that may be formed between valid cells). FIG. 7 shows an embodiment of an arrangement 106 of temporal cell codes that enables the correspondence mapping calculation engine 42 to identify the boundaries of the cells in the capture plane based on the arrangement of the temporal cell code values. In FIG. 7, each of the symbol values A, B, C, and D represents a respective temporal pixel code (i.e., a temporal sequence of light symbols). For example, in some implementations with four light patterns, A may correspond to the temporal pixel code (dark, dark, dark, dark), B may correspond to the temporal pixel code (dark, dark, dark, bright), C may correspond to the temporal pixel code (dark, dark, bright, dark), and D may correspond to the temporal pixel code (dark, dark, bright, bright). The arrangement of temporal cell codes is designed by considering all permutations of a given set of the four symbols A, B, C, and D to form a super block that includes twenty four cells arranged in four rows and six columns. The upper left block is flipped horizontally and vertically to maximize overlap. The super block may be arranged with other similar super blocks to maximize repeating symbols. For example, the next super block based on symbols A, B, C, and D may be added to the right of the super block shown in FIG. 7 since the A and B temporal pixel codes would repeat. A larger light pattern is formed from the arrangements of such super blocks. In other embodiments, temporal cell codes may be arranged with repeating symbols along the boundaries but not necessarily using super blocks.

In the embodiment shown in FIG. 7, adjacent non-overlapping cells (e.g., cell 90 and cell 92) are encoded so that they share at least one temporal pixel code in common at pixel locations along their shared boundary. For example, cell 90 and cell 92 share the temporal pixel codes B and D at pixel locations along their shared boundary 94. An invalid cell 91 is formed by placing a window that overlaps the valid cells 90, 92. In general, the shared temporal pixel code codes need not be aligned horizontally or vertically so long as the adjacent cells share at least one temporal pixel code along the common boundary. During decoding, the correspondence mapping calculation engine 42 slides a 2×2 window or a 5×5 window over the arrangement of temporal cell codes shown in FIG. 7. The groups of pixel clusters that do not have any duplicate temporal pixel codes are labeled as valid, whereas the groups of pixel clusters that have any duplicate temporal pixel codes are labeled as invalid by design.

FIG. 8 shows an embodiment of another arrangement 108 of temporal cell codes using overlapping cells. In the illustrated implementation, the temporal cell codes are arranged so that the correspondence mapping calculation engine 42 can quickly identify the borders of the regions in the capture plane corresponding to valid temporal cell codes. In this implementation, instead of using a spatial arrangement of non-overlapping cells of 2×2 pixels with super blocks as in the temporal cell code arrangement 106, the temporal cell code arrangement 108 uses overlapping cells of 2×2 pixels such that any adjacent 2×2 pixel grouping results in a unique pattern. FIG. 8 shows an 10×3 (effective resolution) arrangement of overlapping cells such that any 2×2 grouping of spatial pixel clusters results in a unique arrangement of the seven symbols ranging from A through G (e.g., ABCD, BCDF, CDFA, etc). It should be clear that the more temporal symbols available, the easier it is to form larger overlapping patterns.

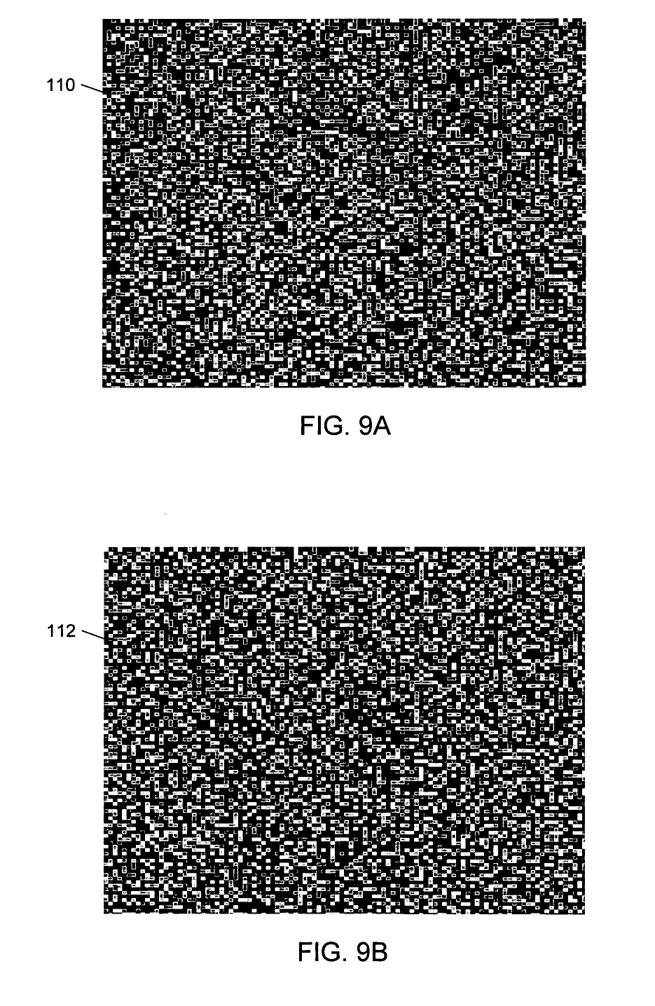

FIGS. 9A and 9B show respective light patterns 110, 112 for the two pattern, eight color solution (P=2, C=8, M=N=2) described above, where the different shades of gray represent respective ones of the eight different colors. In some embodiments, light patterns of the type shown in FIGS. 9A and 9B may be determined by the following greedy search optimization process. The process begins with a random initialization seed, which initializes a random number generator. For a given minimum resolution (e.g., 104×104), the correspondence estimation system 10 selects an initial 2×2 temporal cell code out of the set of permissible unused codes. The correspondence estimation system 10 marks the selected code as having been selected. The correspondence estimation system 10 then randomly picks out an unused code that shares the same symbols with its leftmost neighbor (e.g., if the first code is:

$$( \begin{matrix}a & b \\ c & d\end{matrix} ) \qquad ( 10 )$$

then the next code looks like:

$$( \begin{matrix}b & υ \\ d & ω\end{matrix} ) \qquad ( 11 )$$

where υ and ω represent different temporal pixel codes. The correspondence estimation system 10 continues filling up the coordinate system in the projection plane until it encounters a temporal cell code that has been used, in which case the correspondence estimation system 10 randomly selects a different temporal cell code that satisfies the above constraints. When the correspondence estimation system 10 moves down to the next row, there will be only one degree of freedom in the lower right corner of the cells for selecting unique temporal cell codes. If the correspondence estimation system 10 cannot find a temporal cell code that has not been used already, the process terminates and starts over with a new random initialization seed. If the correspondence estimation system 10 is successful, then the correspondence estimation system 10 has found an overlapping and non-repeating coverage of 2×2 codes at the specified resolution.

5. Summary

In the embodiments that are described in detail above, the correspondence mapping calculation engine 42 is operable to generate the correspondence mapping 44 without information about the exact 3-D locations of the projector 14 and the camera 16, and without information about intrinsic camera and projector calibration parameters that might be derived from a pre-calibration setup process. Instead of solving for three-dimensional structure, the correspondence estimation system 10 addresses the correspondence problem by using the projected light patterns to pinpoint the exact locations of the coordinates in the projection plane 62 of the projector 14 that map to the corresponding locations in the capture plane 72 of the camera 16. In addition, the decoded light symbol sequence at every valid pixel in the capture plane 72 identifies the corresponding location in the projection plane 62 directly; no additional computation or searching is required.

### IV. Detecting Color Texture

In addition to determining correspondence mappings between the projection plane of the projector 14 and the capture plane of the camera 16, some embodiments of the correspondence estimation system determine the color texture of the scene 24. To this end, the correspondence estimation system 10 captures light from the scene 24 at the pixels of the capture plane when the scene 24 is not being actively illuminated by the projector 14.

In some of the embodiments described above, the light patterns are designed so that every temporal pixel code includes at least one dark symbol corresponding to no illumination by the projector 14. In these embodiments, each pixel in the capture plane is guaranteed to receive at least one dark symbol during the projection of the sequence of P light patterns. With respect to these embodiments, the correspondence estimation system 10 generates a color texture map that includes the color synchronously captured at each pixel in the capture plane during the projection of a dark symbol at the corresponding capture plane pixel location. The captured color information is stored in a machine-readable medium, such as a non-volatile memory (e.g., a semiconductor memory device, such as EPROM, EEPROM; a flash memory device; a magnetic disk such as an internal hard disk and a removable disk; a magneto-optical disk; and an optical disk, such as CD, CD-ROM, DVD-ROM, DVD-RAM, and DVD-RW).

Note that the process that is implemented by these embodiments synthetically creates a non-illuminated image of the scene 24, in contrast to methods in which the color texture of the scene 24 is capture when an all-black reference image is projected onto the scene 24. In this way, these embodiments avoid a separate capture step, thus speeding up the capture process and enabling simultaneous capture of both texture and shape information.

### V. View Synthesis

The correspondence mapping information may be used by the computer 18 to synthesize synthetic views of the scene 24. In implementations in which calibration parameters have been determined, the calibration parameters may be used to convert the correspondence mapping into 3-D information, which in turn may be used to create three-dimensional models of the scene 24.

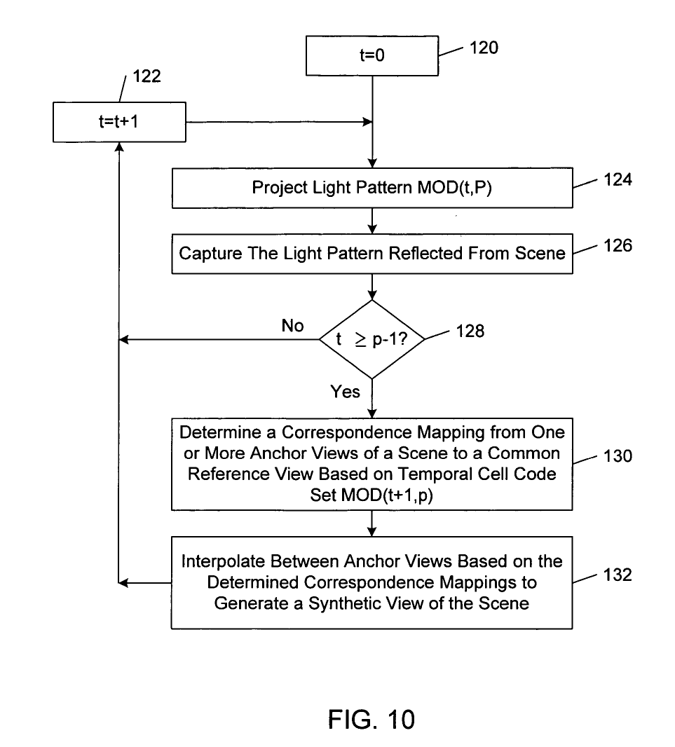

FIG. 10 shows an embodiment of a method of synthesizing a view of the scene 24. Briefly, in accordance with this method, the pattern projection and capture module 40 projects a repeating sequence of P light patterns. The correspondence mapping calculation module 42 determines a respective correspondence mapping for each set of P successively projected light patterns, where each of the light pattern sets is defined by a sliding temporal window that is incremented temporally with respect to the preceding window.

In operation, the correspondence estimation system 10 initializes the clocking variable t to zero (block 120). The pattern projection and capture module 40 projects light pattern MOD(t,P) onto the scene 24, where P is the number of light patterns in the sequence that is repeated (block 124). MOD(t,P) is the modulus function that returns the remainder of t/P. Thus, in the first iteration t=0, MOD (t,P) is equal to 0 and the first light pattern (e.g., light pattern 0) is projected onto the scene. The pattern projection and capture module 40 captures the light pattern reflected from the scene (block 126). If the clocking variable t is less than P−1 (block 128), the clocking variable t is incremented by one (block 122) and then the process is repeated for the next light pattern in the sequence (blocks 122-126).

If the clocking variable t is at least equal to P31 1 (block 128), the correspondence mapping calculation engine 42 determines a correspondence mapping from one or more anchor views of the scene to a common reference view based on the temporal cell code set MOD(t+1,P) (block 130). In the illustrated embodiments, the projection plane and the capture plane are anchor views. In implementations of the correspondence estimation system 10 that include more than one camera, the capture plane of each additional camera also constitutes an anchor view. The correspondence mappings may be determined in accordance with one or more of the embodiments described herein.

The correspondence estimation system 10 interpolates among the given anchor views based on the determined correspondence mappings to generate a synthetic view of the scene 24 (block 132). Because there is an inherent correspondence mapping between the capture plane and the projection plane, the anchor view corresponding to the projection plane also may be used for view interpolation. Thus, in the embodiments described below, when view interpolation is performed with a single camera, the interpolation transitions linearly between the camera's location and the projector's location. In other embodiments, view interpolation may be performed along two dimensions (areal view interpolation), three dimensions (volume-based view interpolation), or even higher dimensions.

In one embodiment, view interpolation is performed along one dimension (linear view interpolation). Linear view interpolation involves interpolating color information as well as dense correspondence or geometry information defined among two or more anchor views. In some embodiments, one or more cameras form a single ordered contour or path relative to the object/scene (e.g., configured in a semicircle arrangement). A single parameter specifies the desired view to be interpolated, typically between pairs of cameras. In some embodiments, the synthetic views that may be generated span the interval [0,M], where M has a positive integer value and the anchor views located at every integral value. In these embodiments, the view interpolation parameter is a floating point value in this expanded interval. The exact number determines which pair of anchor views are interpolated between (the floor( ) and ceiling( ) of the parameter) to generate the synthetic view. In some of these embodiments, successive pairs of anchor views have equal separation of distance 1.0 in parameter space, independent of their actual configuration. In other embodiments, the space between anchor views in parameter space is varied as a function of the physical distance between the corresponding cameras.

In some embodiments, a synthetic view may be generated by linear interpolation as follows. Without loss of generality, the following discussion will focus only on interpolation between a pair of anchor views. A viewing parameter α that lies between 0 and 1 specifies the desired viewpoint. Given α, a new image quantity p is derived from the quantities p₁ and p₂ associated with the first and second anchor views, respectively, by linear interpolation:
p=(1−α)p₁+αp₂=p₁+α(p₂−p₁) (12)
In some embodiments, a graphical user interface may display a line segment between two points representing the two anchor views. A user may specify a value for α corresponding to the desired synthetic view by selecting a point along the line segment being displayed. A new view is synthesized by applying this expression five times for every image pixel to account for the various imaging quantities (pixel coordinates and associated color information). More specifically, suppose a point in the 3-D scene projects to the image pixel (u,v) with generalized color vector c in the first anchor view and to the image pixel (u′,v′) with color c′ in the second anchor view. Then, the same scene point projects to the image pixel (x,y) with color d in the desired synthetic view of parameter α given by:

$$\begin{matrix}( x , y ) = ( ( 1 - α ) \cdot u + α \cdot {u}^{′} , ( 1 - α ) \cdot v + α \cdot {v}^{′} ) \\ = ( u + α \cdot ( {u}^{′} - u ) , v + α \cdot ( {v}^{′} - v ) )\end{matrix} \\ d = ( 1 - α ) \cdot c + α \cdot {c}^{′} = c + α \cdot ( {c}^{′} - c ) \qquad ( 13 )$$

The above formulation reduces to the first anchor view for α=0 and the second anchor view for α=1. This interpolation provides a smooth transition between the anchor views in a manner similar to image morphing, except that parallax effects are properly handled through the use of the correspondence mapping. In this formulation, only scene points that are visible in both anchor views (i.e., points that lie in the intersection of the visibility spaces of the anchor views) may be properly interpolated.

In other embodiments with K anchors (K>1), one can linearly interpolate the quantities using

$$p = {\sum }_{k = 1}^{K} {α}_{k} {p}_{k} \\ s . t . {\sum }_{k = 1}^{K} {α}_{k} = 1 \qquad ( 14 )$$

In these cases, one can derive appropriate visualizations for the user based on the K−1 dimensional simplex to specify these alpha parameters to properly interpolate among the anchors. One embodiment for three anchor views uses areal interpolation in a triangle with two degrees of freedom.

In other embodiments, for proper depth ordering with view interpolation, one can estimate the epipolar geometry between the synthesized view and the reference view, then modify the rendering order of the pixels based on the projection of the epipole. In this way, one can ensure that the depth order is maintained in the synthesized view without having to explicitly compute 3-D shape.

After the synthetic view of the scene has been generated (block 132), the clocking variable t is incremented by one (block 122) and the process is repeated for the next sliding temporal window (blocks 122-132).

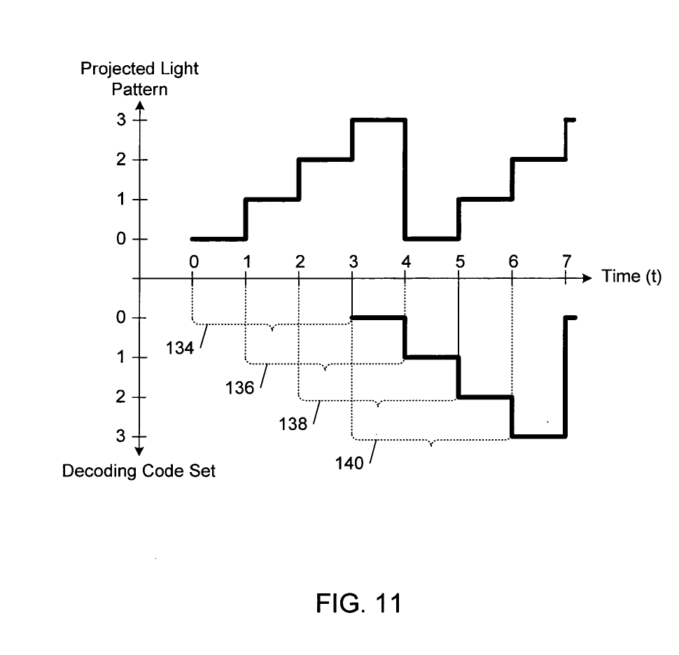

FIG. 11 shows a repeating sequence of P=4 light patterns that are projected by the projector 14 and the sequence of four temporal cell code sets that are used by the correspondence mapping calculation module 42 to determine the correspondence mappings plotted as a function of the clocking variable t. During the first four clocking cycles (t=0, 1, 2, 3), the sequence of light patterns 0, 1, 2, 3 are projected onto the scene. The correspondence mapping calculation module 42 does not begin to determine correspondence mappings until after the fourth clocking cycle. The correspondence mapping calculation module 42 uses the temporal cell code set 0 to decode the first set of light patterns (i.e., light patterns 0, 1, 2, 3), which is defined by the temporal window 134. The correspondence mapping calculation module 42 uses the temporal cell code set 1 to decode the second set of light patterns (i.e., light patterns 1, 2, 3, 0), which is defined by the temporal window 136. The correspondence mapping calculation module 42 uses the temporal cell code set 2 to decode the third set of light patterns (i.e., light patterns 2, 3, 0, 1), which is defined by the temporal window 138. The correspondence mapping calculation module 42 uses the temporal cell code set 3 to decode the fourth set of light patterns (i.e., light patterns 3, 0, 1, 2), which is defined by the temporal window 140.

In some implementations, if the color texture or decoded projector position changes drastically from its current measurement for a given pixel, the pixel is flagged and the correspondence estimation system 10 uses the next two light patterns to decode a valid position for this pixel.

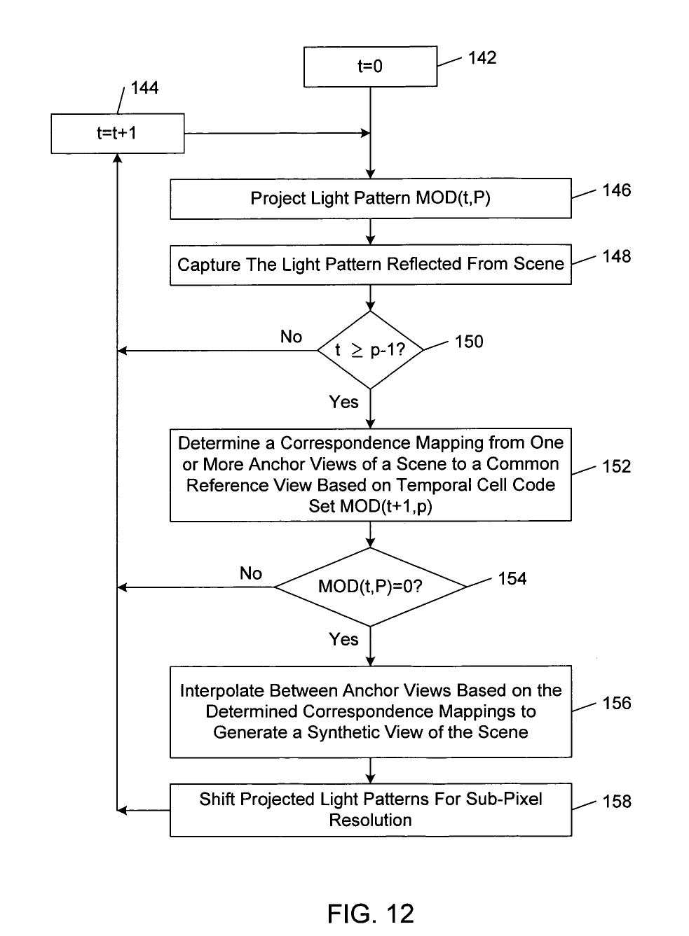

FIG. 12 shows an implementation of the view synthesizing method shown in FIG. 10, in which the light patterns are offset or shifted after each repeating light pattern cycle (e.g., after each sequence of P light patterns has been projected) to estimate higher-resolution correspondence mappings over time.

In this embodiment, the correspondence estimation system 10 initializes the clocking variable t to zero (block 142). The pattern projection and capture module 40 projects light pattern MOD(t,P) onto the scene 24, where P is the number of light patterns in the sequence that is repeated (block 146). The pattern projection and capture module 40 captures the light pattern reflected from the scene (block 148). If the clocking variable t is less than P−1 (block 150), the clocking variable is incremented by one (block 144) and the process is repeated for the next light pattern in the sequence (blocks 144-148).

If the clocking variable t is at least equal to P−1 (block 150), the correspondence mapping calculation engine 42 determines a correspondence mapping from one or more anchor views (e.g., projection plane and the capture plane) of the scene 24 to a common reference view based on the temporal cell code set MOD(t+1,P) (block 152). The correspondence mappings may be determined in accordance with one or more of the embodiments described herein.

If MOD(t,P) is not equal to 0 (block 154), the clocking variable is incremented by one (block 144) and the process is repeated (blocks 144-152). If MOD(t,P) is equal to 0, the correspondence estimation system 10 interpolates between anchor views based on the determined correspondence mappings to generate a synthetic view of the scene 24 (block 156). The view interpolation may be performed in accordance with the method described above in connection with FIG. 10.

Before the clocking variable is incremented by one (block 144) and the process is repeated for the next repeating light pattern cycle, the pattern projection and capture module 40 shifts the projected light patterns for sub-pixel resolution (block 158). In some implementations, the light patterns are shifted by horizontal and vertical amounts ΔH and ΔV that are smaller than the size of the pixels in the projection plane. The light patterns may be shifted mechanically or using software to control locations of the light patterns with respect to the scene 24.

In another embodiment, the arrangement of cells in each of the light patterns may be randomized after each repeating cycle (e.g., after each sequence of P light patterns has been projected) to improve decoding.

### VI. Conclusion

The embodiments that are described above provide an automated approach for determining a correspondence mapping between a camera and a projector that is based on the projection of light patterns that spatio-temporally encode correspondence information. This approach does not require strong calibration between the projector and the camera in order to determine the correspondence mapping. The light patterns encode pixels in the coordinate system of the projector in ways that allow the reflected light patterns that are captured at the capture plane of the camera to be decoded based on spatially local information. In this way, redundant temporal pixel codes may be used in encoding the correspondence information so that the total number of light patterns may be reduced. This increases the speed with which correspondence mappings may be determined, therefore enabling faster capture and synthesis for many applications including those for time-varying scenes.

Other embodiments are within the scope of the claims.

For example, in the illustrated embodiments, the correspondence estimation system 10 includes only a single projector 14. In other embodiments, however, the correspondence estimation system may include more than one projector for projecting light patterns onto the scene 24. The system may be used to efficiently calibrate and register the projectors to a common coordinate system. The correspondence estimation system 10 also includes only a single camera 16. In other embodiments, however, the correspondence estimation system 10 may include more than one imaging device for monitoring the images that are projected onto the scene 24 and providing feedback to the computer 18. In these embodiments, multiple cameras capture respective sets of light patterns reflected from the scene 24. In some implementations, the results from all cameras are remapped to a common reference coordinate system and stitched together to form a higher resolution panoramic image. In some implementations, multiple cameras may be required when the resolution of a single camera is insufficient to capture the light patterns projected by the projector 14 (e.g., when images are projected onto a very large display area).

What is claimed is:

1. A method, comprising:
projecting onto a scene a sequence of light patterns comprising cells having respective patterns of light symbols, the projected sequence of light patterns encoding pixels in a projection plane with respective temporal pixel codes corresponding to respective temporal sequences of light symbols coinciding with the locations of corresponding pixels, and uniquely encoding cells in the projection plane with respective temporal cell codes comprising respective sets of temporal pixel codes corresponding to respective sequences of light pattern cells;
capturing at regions of a capture plane respective temporal sequences of light patterns reflected from the scene; and
determining a correspondence mapping between the regions of the capture plane and corresponding cells in the projection plane based at least in part on correspondence between the respective light pattern sequences captured at the capture plane regions and the temporal cell codes projected from the projection plane.

2. The method of claim 1, wherein the projected sequence of light patterns uniquely encodes non-overlapping cells in the projection plane with unique respective temporal cell codes.

3. The method of claim 1, wherein the projected sequence of light patterns uniquely encodes overlapping, spatially displaced cells in the projection plane with unique respective temporal cell codes.

4. The method of claim 1, wherein at least one of the light patterns comprises at least one pair of duplicate cells.

5. The method of claim 1, wherein each of the cells comprises a pattern of M rows and N columns of light symbols, M and N having integer values and at least one of M and N has a value of at least two.

6. The method of claim 5, wherein the light symbols have respective colors selected from a set of C colors, C having an integer value of at least two.

7. The method of claim 6, wherein the projecting comprise encoding each of the pixels in the projection plane with a respective temporal sequence of P light patterns, P having an integer value of at least two.

8. The method of claim 7, wherein C=8, P=2, M=2, and N=2.

9. The method of claim 7, wherein C=2, P=4, M=2, and N=2.

10. The method of claim 7, wherein C=3, P=3, M=2, and N=2.

11. The method of claim 1, wherein each light pattern consists of at least one cell.

12. The method of claim 1, wherein the projecting comprises projecting features demarcating the cells in the projection plane.

13. The method of claim 12, wherein the projecting comprises projecting a respective detectable boundary feature around each of the cells in the light patterns.

14. The method of claim 1, wherein groups of the projection plane pixels that are non-coincident with the projection plane cells are encoded with invalid temporal cell codes.

15. The method of claim 14, wherein adjacent ones of the projection plane cells are encoded with respective temporal cell codes having at least one temporal pixel code in common at adjacent pixel locations in the projection plane.

16. The method of claim 15, wherein the determining comprises labeling as invalid regions in the capture plane encoded with cell codes having at least one pair of duplicate temporal pixel codes.

17. The method of claim 1, wherein each of the temporal pixel codes is free of light symbols of same color.

18. The method of claim 1, wherein the determining comprises decoding the captured temporal sequences of light patterns.

19. The method of claim 18, wherein the decoding comprises assigning respective ones of the temporal pixel codes to pixels in the capture plane.

20. The method of claim 19, wherein the decoding comprises grouping capture plane pixels assigned same temporal pixel codes into spatial clusters of pixels.

21. The method of claim 20, wherein the decoding comprises labeling as valid groups of pixel clusters encoded with respective ones of the temporal cell codes.

22. The method of claim 21, wherein the decoding comprises labeling as indeterminate ones of the pixels in the capture plane encoded with temporal pixel codes designated as invalid.

23. The method of claim 21, wherein the decoding comprises mapping locations in valid pixel cluster groups in the capture plane to respective locations in corresponding cells in the projection plane.

24. The method of claim 23, wherein the mapping comprises matching temporal cell codes encoding the spatial cluster groups in the capture plane to temporal cell code entries in a table relating temporal cell codes with locations in projection plane cells.

25. The method of claim 23, wherein the decoding comprises mapping light symbol intersection points in valid pixel cluster groups in the capture plane to respective light symbol intersection points in corresponding cells in the projection plane.

26. The method of claim 1, further comprising:
during the projecting, capturing color information from the scene at locations in the capture plane corresponding to dark light symbols in the projected light patterns; and
storing the captured color information in a machine-readable medium.

27. The method of claim 1, wherein the projecting comprises projecting a repeating sequence of the light patterns.

28. The method of claim 27, wherein each of the repeating sequences comprises P light patterns, P having an integer value of at least two, and the determining comprises determining a respective correspondence mapping for each set of P successively projected light patterns.

29. The method of claim 28, wherein the light pattern sets are defined by respective sliding temporal windows temporally incremented with each successively projected light pattern.

30. A machine-readable medium storing machine-readable instructions for causing a machine to perform operations comprising:
projecting onto a scene a sequence of light patterns comprising cells having respective patterns of light symbols, the projected sequence of light patterns encoding pixels in a projection plane with respective temporal pixel codes corresponding to respective temporal sequences of light symbols coinciding with the locations of corresponding pixels, and uniquely encoding cells in the projection plane with respective temporal cell codes comprising respective sets of temporal pixel codes corresponding to respective sequences of light pattern cells;
capturing at regions of a capture plane respective temporal sequences of light patterns reflected from the scene; and
determining a correspondence mapping between the regions of the capture plane and corresponding cells in the projection plane based at least in part on correspondence between the respective light pattern sequences captured at the capture plane regions and the temporal cell codes projected from the projection plane.

31. An apparatus, comprising:
a projector;
an imaging device; and
a processing system operable to
control the projector to project onto a scene a sequence of light patterns comprising cells having respective patterns of light symbols, the projected sequence of light patterns encoding pixels in a projection plane with respective temporal pixel codes corresponding to respective temporal sequences of light symbols coinciding with the locations of corresponding pixels, and uniquely encoding cells in the projection plane with respective temporal cell codes comprising respective sets of temporal pixel codes corresponding to respective sequences of light pattern cells;
control the imaging device to capture at regions of a capture plane respective temporal sequences of light patterns reflected from the scene; and
determine a correspondence mapping between the regions of the capture plane and corresponding cells in the projection plane based at least in part on correspondence between the respective light pattern sequences captured at the capture plane regions and the temporal cell codes projected from the projection plane.

32. An apparatus, comprising:
means for projecting onto a scene a sequence of light patterns comprising cells having respective patterns of light symbols, the projected sequence of light patterns encoding pixels in a projection plane with respective temporal pixel codes corresponding to respective temporal sequences of light symbols coinciding with the locations of corresponding pixels, and uniquely encoding cells in the projection plane with respective temporal cell codes comprising respective sets of temporal pixel codes corresponding to respective sequences of light pattern cells;
means for capturing at regions of a capture plane respective temporal sequences of light patterns reflected from the scene; and
means for determining a correspondence mapping between the regions of the capture plane and corresponding cells in the projection plane based at least in part on correspondence between the respective light pattern sequences captured at the capture plane regions and the temporal cell codes projected from the projection plane.
